(19) United States
(12) Patent Application Publication
(10) Pub. No.: US 2017/0279678 A1
(43) Pub. Date: Sep. 28, 2017

(54) Containerized Configuration

(71) Applicant: Microsoft Technology Licensing, LLC, Redmond, WA (US)

(72) Inventors: Christopher Peter Kleynhans, Bellevue, WA (US); Eric Wesley Wohllaib, Fall City, WA (US); Paul McAlpin Bozzay, Bellevue, WA (US); Morakinyo Korede Olugbade, Seattle, WA (US); Frederick J. Smith, Redmond, WA (US); Benjamin M. Schultz, Bellevue, WA (US); Gregory John Colombo, Kirkland, WA (US); Hari R. Pulapaka, Redmond, WA (US); Mehmet Iyigun, Kirkland, WA (US)

(21) Appl. No.: 15/082,914

(22) Filed: Mar. 28, 2016

(51) Int. Cl. H04L 12/24

(52) U.S. Cl. CPC H04L 41/0816

(57) ABSTRACT

Configuring a node. A method includes at a first configuration layer, modifying configuration settings. The method further includes propagating the modified configuration settings to one or more other configuration layers implemented at the first configuration layer to configure a node.

### BACKGROUND

### Background and Relevant Art

Computers and computing systems have affected nearly every aspect of modern living. Computers are generally involved in work, recreation, healthcare, transportation, entertainment, household management, etc.

Operating systems in computing systems may use hardware resource partitioning. A popular resource partitioning technique is virtual machine-based virtualization, which enables a higher density of server deployments, ultimately enabling scenarios such as cloud computing. Recently, container-based (sometimes referred to as namespace based) virtualization offers new promises including higher compatibility and increased density. Higher compatibility means lower costs of software development. Higher density means more revenue for the same cost of facilities, labor and hardware.

Today's operating systems have a myriad of configuration settings which are read from and stored on the system. Configuration settings include various aspects of an operating system, its dependent hardware and associated applications, devices, and peripherals. Beyond locally configured settings and policy, additional inputs are also sourced from more global sources such as a mobile device manager, Active Directory/LDAP servers, network management tools and other control infrastructure. In virtual machine-based virtualized environments, each virtual machine has its own full copy of system configuration, distinct from that which exists on the host and other virtual machines that also run on the same host. Virtual machine-based virtualization incurs overhead in creating and reading from copies of data that is large part shared. This overhead may include overhead due to separately managing many different instances of the same settings. Additionally, consideration may be given to the size of a storage footprint for storing copies of configuration data. In container-based virtualization, namespace isolation can be used to share resources to increase density and efficiency.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment implementing configuration layers for containerized configurations. The method includes acts for configuring a node. The method includes at a first configuration layer, modifying configuration settings. The method further includes propagating the modified configuration settings to one or more other configuration layers implemented on the first configuration layer to configure a node.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example host operating system and configuration layer management apparatus;

FIG. 2 illustrates another example of a host operating system in configuration layer management apparatus;

FIG. 3 illustrates a specific example of a database filter for filtering configuration settings;

FIG. 4 illustrates a state diagram showing various configuration states; and

FIG. 5 illustrates a method of configuring a containerized entity.

### DETAILED DESCRIPTION

Embodiments described herein can implement a containerized based configuration approach. In a containerized based configuration approach, various hierarchical configuration layers are used to configure entities. Additionally, filters can be applied to configuration layers to accomplish a desired configuration for an entity. In particular, an entity, such as an operating system kernel, can have different portions of different configuration layers exposed to it such that configuration from different configuration layers can be used to configure the entity, but where the entity operates as if it is running in its own pristine environment. Thus, a given configuration layer could be used as part of a configuration for multiple different entities thus economizing storage, network, and compute resources by multi-purposing them.

Configuration can be dynamically and seamlessly pushed from lower configuration layers to higher configuration layers, to the eventual entity being configured. Embodiments can efficiently use resource system configuration data. This can be used to implement a cross-platform, consistent and performant approach.

While containers benefit from this layered configuration method, other management scenarios may also benefit such as internet and cloud infrastructure management, distributed application management and smartphone management.

A containerized entity is an isolated runtime that uses Operating System resource partitioning. This may be an operating system using hardware-assisted virtualization such as a Virtual Machine. It may be an operating system using Operating-system-level virtualization with complete namespace isolation such as a container. It may be an isolated application running on an operating system using partial namespace isolation (e.g. filesystem and configuration isolation).

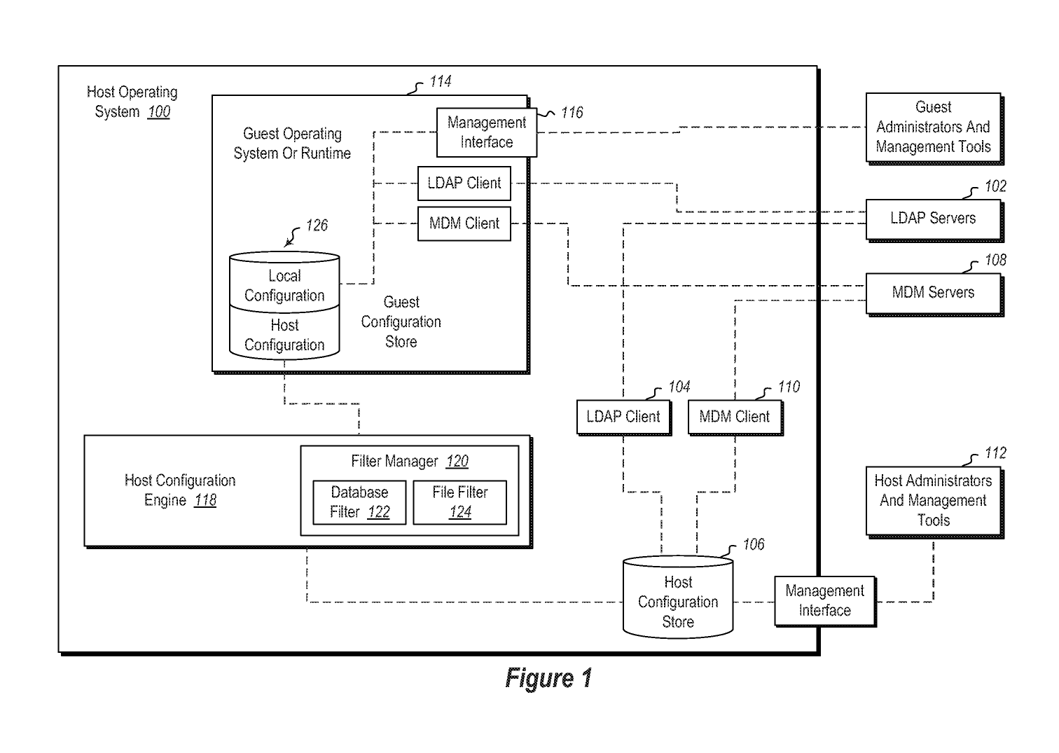

Various components described herein will now be generally discussed with respect to FIG. 1.

FIG. 1 illustrates Lightweight Directory Access Protocol (LDAP) Servers 102. (LDAP) servers 102 provide authentication and authorization, but also provide configuration settings through mechanisms such as Group Policy.

FIG. 1 illustrates an LDAP Client 104. LDAP clients 104 connect to the LDAP servers 102, receive policy and configuration updates and update a host configuration store 106.

FIG. 1 illustrates Mobile Device Management (MDM) Servers 108. MDM servers 108 provide policy and configuration for mobile phones and other computers, illustrated as MDM client 110.

FIG. 1 illustrates Host Administrators and Management Tools 112. Host Administrators and Management Tools 112 provide local configuration to the host operating system 100 (sometimes referred to herein as the “host”), typically for core operating system functions such as managing guest operating systems such as guest operating system 114 (which may alternatively be a runtime). In client scenarios, this could be a local settings application that manages files, applications and local device settings.

FIG. 1 illustrates a Management Interface 116. The Management Interface 116 includes the infrastructure for management of data and operations. This may include a shell (such as a command line) and a set of tools or APIs to interface with the host configuration store. This may also include remote accessibility via networking or other peripherals.

FIG. 1 further illustrates a Host Configuration Store 106. The Host Configuration Store 106 maintains a consistent configuration for the host operating system 100. This may be implemented as a database, as one or more configuration files, in a configuration graph, etc. It may reside on disk, in memory or a combination of both.

FIG. 1 further illustrates a Host Configuration Engine 118. The Host Configuration Engine 118 filters the host configuration store 106 for the guest operating system 114, providing the core configuration of the guest operating system 114. The Host Configuration Engine 118 may contain a filter manager 120 that filters host configuration based on operating system type and host configuration store type. In some embodiments, a database filter 122 and a file filter 124 are included.

FIG. 1 further illustrates a Guest Configuration Store 126. The Guest Configuration Store is the configuration store that the guest operating system 114 uses and is created through a composition of local configuration implemented specifically for the particular guest operating system 114 instance and host configuration obtained from the host configuration store 106 as filtered by the filter manager 120. In embodiments implemented using Windows®, available from Microsoft Corporation of Redmond, Wash., a registry database contains the store for a host and all guests. The database filter provides the mechanisms to virtualize this. However, other implementations may use database approaches, configuration file approaches, configuration graph approaches, or various combinations of approaches. Additionally, there may be separate database instance or configuration files set for each of the guests and the filter manager 120 provides the facilities to compose these into one usable configuration.

Embodiments may include a Guest Configuration Engine (not shown). A guest operating system may implement a nested scenario in which it hosts additional guest operating systems. In this scenario, there may be a Guest Configuration Engine included in the guest operating system 114 that will function as the host configuration engine does, merely sourcing the guest configuration store and filtering it to the children instances of the guest operating system 114.

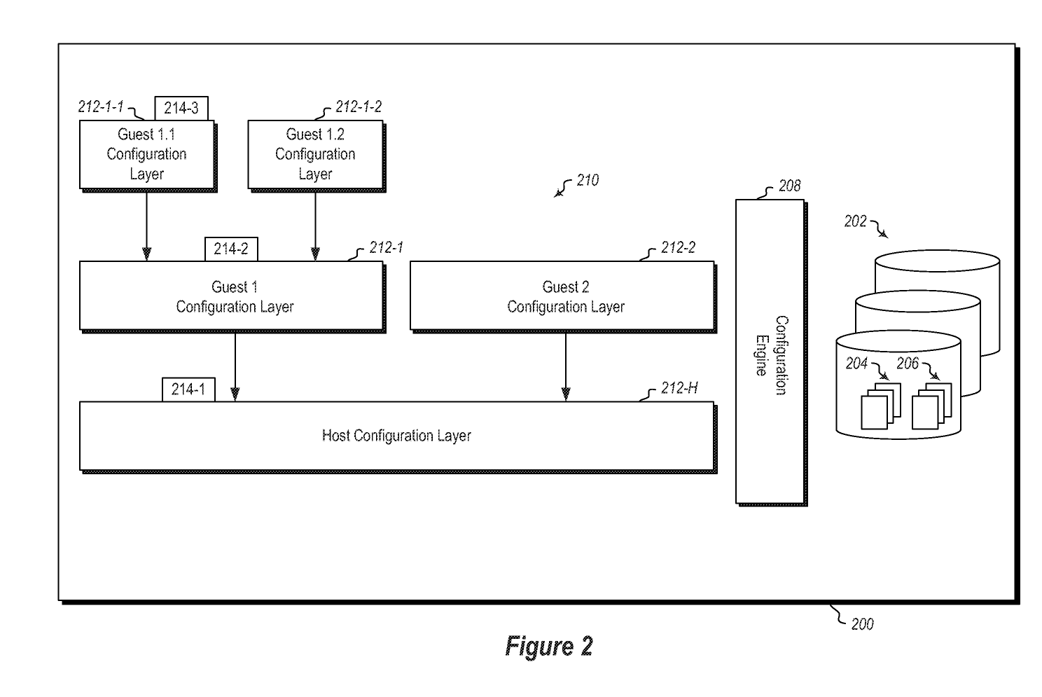

Referring now to FIG. 2, additional details of various embodiments are now illustrated. Embodiments may implement a system 200 to manage and apply configurations. The system 100 includes one or more configuration stores 202 for hosts and/or containers (e.g., stores 106 and 126 respectively). Configuration stores 202 may include one or more data sets 204, each of which defines a base configuration. Further, configuration stores 202 may include one or more data sets 206 that each define a higher configuration layer configuration.

Embodiments may include a configuration engine 208. The configuration engine 208 can provides a dynamic, unified view of multiple configurations. The configuration engine 208 manages configuration changes for any configuration layer, ensuring the appropriate configuration layers reflect these changes. The configuration engine 208 further provides a filter manger (such as filter manager 120 illustrated in FIG. 1) with operating system-specific filters to bridge configuration gaps (e.g. different operating system versions or types). Note that the “configuration engine” is described as one component for illustrative purposes. In any given implementation it could be composed of multiple components and/or sub-components; it could also be packaged and stored in these pieces. In some embodiments, the configuration engine may be implemented in a distributed fashion, with portions of the configuration engine stored at various different machines in different locations.

The configuration engine 208 may be configured to inspect one or more configuration stores 202 and determine the appropriate configuration data sets for a given set of configuration layers (e.g. based on policy, configuration, available hardware, operating system version, location, etc.).

The configuration engine 208 may be configured to load the configuration layers or provide the host operating system and/or the guest operating system the instructions to load it (e.g. location, file name, etc.).

The configuration engine 208 may be configured to provide de-duplication. Each logical configuration view is composed of a base configuration layer and one or more distinct and distinguishable configuration layers in a configuration stack, such as configuration stack 210. Base and intermediate configuration layers are shared with multiple operating system instances with change control. For example, in the system 100, an operating system using the guest configuration layer 212-1-1 and an operating system using the guest configuration layer 212-1-2 share configuration layers 212-1 and 212-H.

The configuration engine 208 may be configured to change the configuration layers through adding, inserting and removing one or more layers. When this occurs, the configuration engine writes dependent settings to the upper layer, enabling independence for those settings. A lower layer may then be added, inserted or deleted. After the changes are complete, configuration engine 208 will re-map the settings between the new adjacent layers and perform de-duplication of settings.

The configuration engine 208 may be configured to provide location. The assignment and tracking of an operating system instance and to what configuration layer(s) and location(s) it is assigned can be managed by the configuration engine 208. This may include efficient access to configuration data as configuration settings are read, updated and deleted. The configuration engine 208 may embed this location information in the configuration layers, in configuration store 202, or maintain additional data structures to track this.

The configuration engine 208 may be configured to provide isolation. Some scenarios require isolation to not expose information from the host into the container. To implement this, the configuration engine 208 may provide a logical configuration to each operating system instance, isolated from other operating system instances for data access and manipulation.

The configuration engine 208 may be configured to provide synchronization and change control. In some embodiments, copy-on-write is applied to ensure writes to the configuration layers (e.g., configuration layers 212-H, 212-1, 212-2, 212-1-1 and 212-1-2) are maintained and respected. In some embodiments, these are locally maintained and not written to underlying configuration layers (which may be shared). For example, a change to configuration layer 112-1-1 will not result in a change to configuration layer 112-2 or 112-H. However, as will be illustrated below, in some embodiments an entity using an upper level configuration layer may be able to cause changes to configuration at a lower level configuration layer.

The configuration engine 208 may be configured to provide down-stack mutability. In particular, the configuration engine 208 may include the ability to determine when to write to a local, isolated copy-on-write store, and when to write to an underlying configuration layer. In particular, embodiments may be able to change a configuration for an OS kernel by changing a local configuration layer and/or by changing an underlying configuration layer. For example, assume that an OS kernel is running using the configuration layer 212-1-1. Embodiments could update the OS kernel by performing a write to the configuration layer 212-1-1, the configuration 212-1 and/or the configuration layer 212-H.

However, the ability to write to underlying configuration layers may be controlled based on certain criteria and depending on different particular scenarios. For example, in some embodiments, only a host system may be able to make changes to underlying configuration layers, while in other embodiments, a container may be able to make or request changes to underlying configuration layers.

For example, if an application is running in a sandboxed fashion to prevent the application from interfering with other system functions, then a container associated with the application may not be permitted to make changes to underlying configuration layers. However, there may still be a desire to have those underlying configuration layers changed. For example, if communication ports are changed on the underlying host system 100, there may be a desire that a sandboxed application running on the system continue to run seamlessly even though underlying ports are changed. To accomplish this, a host system can modify the host configuration layer 212-H to configure the communication ports for use by configuration layers on top of the host configuration layer 212-H. These changes are passed through configuration layers 212-1 and e.g., 212-1-1 to a sandboxed application running on the configuration layer 212-1-1 such that the sandboxed application will continue to run seamlessly even though configuration ports have been changed at the host level.

In an alternative embodiment, and application running on the configuration layer 212-1-1 may be implemented for compatibility issues. For example, the system 100 may be designed to host applications in virtual machines running operating systems compatible with the applications. For compatibility issues, there may be a need to modify an underlying configuration layer to allow the applications to run on the system 200. Thus, application requirements can drive the configuration engine 208 to modify underlying configuration layers such as configuration layer 212-1 or configuration layer 212-H to be configured in a fashion that allows applications running on the guest configuration layer 212-1 to operate in a virtual machine on the system 100. For example, the configuration engine 208 may identify that an application needs a particular amount of memory to be able to function. The configuration engine 208 can cause the configuration layer 212-H to be configured for a particular amount of memory to allow the application to run on the configuration layer 212-1-1.

The configuration engine 208 may be configured to provide up-stack mutability. In particular, the configuration engine 208 may be configured with the ability to guarantee namespace isolation by providing a distinct top-configuration layer of the configuration store for each container.

The configuration engine 208 may be configured to provide per-configuration layer notifications. In such embodiments, a subscriber to a particular configuration layer is notified when there is a relevant change in that configuration layer. In other embodiments, configuration layer notifications may be aggregated and presented to the above layers (for upstack mutability) or lower layers (for downstack mutability) if a dependency exists.

Embodiments may be implemented where secure trust classes are applied to areas of the base configuration to protect the host from information disclosure and trust classes are applied to areas of the higher configuration layer configuration to protect specific container configuration from information disclosure to the host.

In some such embodiments, the secure trust classes apply encryption/decryption to hide configuration. In particular, often a configuration layer will include elements that should not be exposed to higher level configuration layers. These can be hidden by encrypting the elements. A higher level configuration layer will need an appropriate key to access an element in a lower level configuration layer. Thus, for example, the configuration layer 212-1 may be restricted from using elements of the host configuration layer 212-H due to the elements in the host configuration layer 212-H being encrypted and the configuration layer 212-1 not having a key to decrypt the elements. However, the configuration layer 212-1 may maintain keys to access elements of the host configuration layer 212-H which are intended to be exposed to the configuration layer 212-1.

Embodiments may be implemented where a nested deployment topology maps to configuration layers in a configuration stack. For example, a virtual machine 214-1 is using a base configuration, such as the host configuration layer 212-H at the bottom of the configuration stack 210 while a virtual machine 214-2 uses the virtualization mechanism of virtual machine 214-1 to run on it; and uses a configuration layer, such as configuration layer 212-1 above the base image. In the illustrated example, a virtual machine 214-3 uses the virtualization mechanism of virtual machine 214-2 to run on it and uses a configuration layer, such as configuration layer 212-1-1 above configuration layer 212-1.

Embodiments may be implemented where one or more nodes in a distributed deployment topology map to configuration layers in the configuration stack and; each of these configuration layers represent the configuration difference between the nodes and the base configuration layer is used as to de-duplicate the configuration across nodes.

Embodiments may be implemented where the operating systems use file-based management. For example, as opposed to the database example illustrated above, such as when embodiments that are implemented in the registry of Windows® available from Microsoft Corporation, of Redmond, Wash., other embodiments may use configuration file based approaches using operating system level configuration files such as the configuration files used in iOS® available from Apple Corporation, of Cupertino Calif., or configuration files used in various Unix® based systems. The configuration engine 208 is able to tag pieces of the configuration files with the appropriate metadata and track entry state as it does with database-based configuration.

Note that some embodiments may use a combination of approaches. For example, consider a system where a Unix® operating system is implemented on top of a Windows® operating system. In such case, the host configuration layer 212-H may be database (e.g., registry) based whereas the configuration layer 212-1-1 may be file (e.g., configuration file based). For example in one embodiment, the configuration engine 208 is provided a policy (not shown) that maps specific configuration points of the Windows® operating system to the equivalents in the Unix® operating system. For example, a network configuration in Windows® may share a network interface with the Unix® operating system. Pointers in the Unix® configuration files would be mapped by the Configuration Engine directly back to the network configuration in the Windows® host. In some embodiments for performance purposes this data would be copied to the guest and re-copied when an update occurs.

In another embodiment, the configuration engine 208 includes its own mapping engine to parse configurations of different operating system types and generate a dynamic mapping.

The following illustrates how configuration changes propagate across layers in a mixed operating system environment. Configurations may be changed through an API, through direct reads/writes, through policy received from an MDM server or LDAP server. Fore example, in the event that a first operating system configuration layer, such as a configuration layer for Windows® available from Microsoft corporation of Redmond Wash., changes impacting a second operating system configuration layer such as a configuration layer for Unix®, the configuration engine 208 monitors the configuration map between the layers for changes.

For example, if the change occurs in a Windows® configuration layer, the configuration engine 208 uses the Windows® registry database API to read the changed value and location and re-map the change onto the Unix® configuration layer. Note that the configuration engine 208 may also read directly from the registry database in some offline scenarios. The mapping is implemented by identifying the Unix® configuration file name and location, parsing the file and finding the equivalent configuration data. The changed configuration data is then written to that file. With some configuration changes, the Unix® daemon may need to be restarted to consume the change.

If the change occurs in the Unix® configuration layer, the configuration engine 208 accesses the appropriate configuration file to read the changed value and location and re-map the change onto the Windows® configuration layer. The mapping is implemented by identifying the Windows® registry key (or registry keys) and location, thus finding the equivalent data. The changed configuration data is then written to that registry key or keys. With some configuration changes, Windows® may need to restart the appropriate services or reboot in order to consume the change.

The following now illustrates additional details with respect to a composition of configuration in a database filter design. Similar principles can be applied to configuration file based designs.

In container-based virtualization, configuration of the guest operating system is composed of a host configuration and guest configuration. One factor to consider when virtualizing a guest configuration includes isolation between the host and the guest. This ensures one guest only sees the relevant configuration of the host's configuration; and in a nested scenario any configuration layer beneath the host. Copy-on-write provides isolation between configuration layers by allowing reading of relevant configuration layers stacked on top of each other but only modifying the configuration layer to which writes are targeted.

Another factor to consider when virtualizing a guest configuration includes isolation between multiple guest instances. This ensures one guest only sees its unique configuration that is added to the relevant configuration from the host; and not the configuration of another guest.

Looking at the illustration shown in FIG. 2, the host configuration layer 212-H provides the base configuration, and then specific differences are added by guest configuration layer 212-1 and guest configuration layer 212-2. However, guest configuration layer 212-1 cannot see guest configuration layer 212-2's configuration. Guest configuration layer 112-11 also hosts two children, guest configuration layers 212-1-1 and 212-1-2. Each of those children build their configuration from guest configuration layer 212-1's configuration. However, each child configuration layer also has isolation from the other. To achieve this, in some embodiments, each configuration layer has pointers to configuration data at the lower configuration layer and builds extended configuration based on these pointers. Caching, as described in more detail below, achieves performance across these configuration layers.

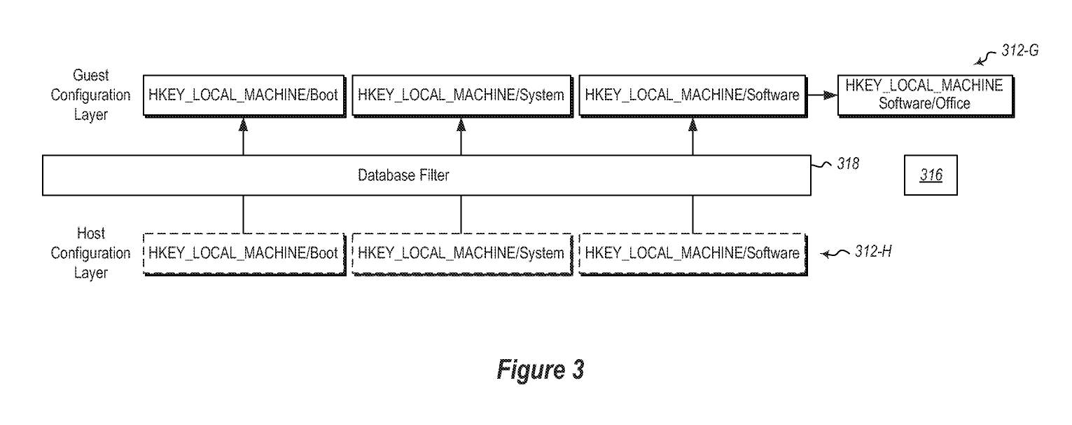

As illustrated in FIG. 3, in Windows Operating Systems available from Microsoft Corporation, of Redmond, Wash., for example, the configuration is handled through a database called the registry. The Windows® registry database is composed of a set registry hives, which store different types of configuration such as device/peripheral information, user information, security information, boot information, etc. In this environment, a filter manager 316 applies a database filter 316 specific to the Windows OS. This database filter is tasked with namespace manipulation, to give the Guest Operating System the illusion it is operating on a non-virtualized registry namespace. The Windows Operating System's registry database supports built-in database virtualization capability through copy-on-write procedures. Copy-on-write (also known as virtual differencing hives) ensure isolation of any writes the container performs to the registry. Each persistent hive is represented as a file on disk, and is loaded into memory when the operating system boots. Each temporary (volatile) hive is dynamically created only in memory and does not persist if the OS instance is shutdown. While this example is specific to Windows, other operating systems may implement other specifics.

Virtual differencing hives are hives that conceptually contain a set of logical modifications to a registry hive. Such a hive only has meaning when these modifications are configuration layered on top of some already existing regular hive to implement configuration virtualization.

Virtual differencing hives are loaded into the registry namespace like regular hives except their mounting is done by a call to a separate API (NtLoadDifferencingKey) that specifies the non-virtualized hive upon which the virtual differencing hive is to be configuration layered. In some implementations, a virtual differencing hive has a non-virtualized hive to configuration layer upon. In other implementations, the virtual differencing hive may contain data that is an extension of or a new instance of the host configuration. See FIG. 3 for an example of where various configuration settings in a host configuration layer 312-H are filtered through a database filter 316 to a guest configuration layer 312-G.

When a virtual differencing hive maps to a non-virtualized host hive, accesses to the registry namespace under the loaded virtual differencing hives do not operate on the hive directly, but instead operate on a merged view of the virtual differencing hive and its non-virtualized host hive. A merged view is composed of the configuration information in the current layer and all layers it depends on below it.

Embodiments may also support multiple configuration layers of guest configuration, so that in some scenarios a guest operating system or container may be nested multiple configuration layers deep to load a virtual differencing hive on top of another virtual differencing hive. Note the multiple configuration layers of guest operating systems may be limited by disk and memory footprint and access speeds.

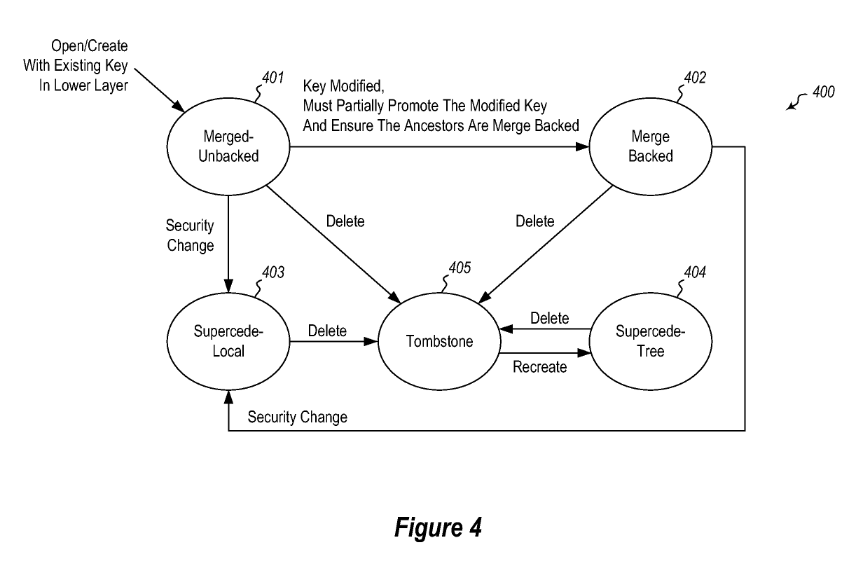

Referring now to FIG. 4, various logical key states are shown. Data entries (also known as keys) in the virtual differencing hive's logical namespace exist in five states in the illustrated example. This state information instructs the database filter 318 as it manages read/modify/delete commands. The five states as illustrated in the state machine 400 shown in FIG. 4 are as follows:

Merge-Unbacked 401: An entry key in this state does not have any modifications in the current guest operating system configuration layer, all queries transparently fall-through to the configuration layer below. The key is unbacked meaning that there is no configuration in the configuration layer below it (e.g., no underlying key nodes).

Merge-Backed 402: An entry key in this state has modifications in this configuration layer that are merged with the configuration layers below.

Supersede-Local 403: This is the case in which a security settings change (relaxing the permission level) on a key entry that appears in a higher configuration layer results in splitting the association with the lower configuration layer and making a local copy in the higher configuration layer. The result is that an entry key in this state supersedes all the configuration layers below it, i.e. queries to this key do not fall-through nor are they merged with the state of configuration layers below.

Supersede-Tree 404: This is the case in which a key entry gets deleted in the guest configuration layer and gets re-created at a later time in the guest configuration layer, including pointers to the related configuration in the host configuration layer. When it is re-created, the entry key is in this state, and the new entry key supersedes all the configuration layers below it and children are not merged with the configuration layer below.

Tombstone 405: An entry key in this state has been deleted in this configuration layer. The key cannot be opened. Tombstone keys can exist in both virtual differencing hives and non-virtualized (non-differencing) hives. In virtual differencing hives this is indicated by a backing key node. In a non-virtualized hive, this state is implied by the absence of such a key node. Tombstone keys in non-differencing hives are used when a key exists in a virtual differencing hive configuration layered above but not in the lowest configuration layer (to allow a creation in a lower configuration layer to be linked up).

These states map directly to the state of the key and are stored with the key both on-disk and in memory. Starting with an empty virtualized differencing hive, the keys in the virtual differencing hive's namespace have Merge-Unbacked semantics (except for the root key which is Merge-Backed), and these keys are those keys in the namespace of the next lowest configuration layer. Individual keys can then move through the various states as illustrated in FIG. 4.

When there is a security change, the modified key is fully promoted, ensuring both that the ancestors are merge backed any children keys are merge backed 402. A security change will have no effect on keys in merge backed 402, supersede-tree 404 and tombstone 405 states.

Note that the host (base) configuration layer 212-H supports merge-backed 402 and tombstone 405 states.

The following now illustrates concepts with respect to in-memory access. Virtualized differencing hives are stored as regular registry hives tagged with metadata to ensure the database knows they are virtualized. This also improves load time performance when a new guest operating system is booted.

The metadata contains: A unique identifier for each guest instance; and a per-hive state tag if all entry keys in that hive have the same state. For example, if an entire hive is merge-unbacked 401, it is tagged as such.

The following now illustrates concepts with respect to on-disk storage. A hive is stored in on-disk with the same metadata as it is stored with in memory. This on-disk configuration may be in a state in which the virtual differencing hive is associated with one or more host operating system instances, or it may be sitting idle, awaiting association with a host operating system instance. This on-disk configuration may be stored in the same location as the host operating system instance, or may be stored remotely on a file server, for example.

Additional metadata when it is stored on disk may include:
Current Host operating system versions the configuration supports.
Current Host operating systems the configuration is associated with.
Software objects that enable information sharing between the host and guest operating systems

If the key is associated with one or more host operating systems, for each instance:
For entry keys in the merge-backed 402 state, the underlying key node's state (or the implied state if the key node does not exist).
For entry keys in the merge-backed 402 state, the entry key's position relative to other entry keys. This includes a configuration layer height field specifying the number of configuration layers below the key and a pointer to a configuration layer information block that is allocated on demand Note that this configuration layer information block may contain a pointer downwards to the configuration layer block of the corresponding entry key in the next lowest configuration layer and the head of a linked list of configuration layer information block in the configuration layer above. This allows for quick traversal up and down the configuration layers. An entry key takes a reference on the corresponding entry key in the configuration layer below, ensuring the lower configuration layer entry key and its corresponding configuration layer info remain valid for the lifetime of the upper configuration layer entry key.

Embodiments may implement a cached design that can be used to achieve performance and scale. Implementing containerized configuration isolation, will result in a minimal negative performance impact for achieving this isolation. Configuration performance directly impacts all operating system activities: Deployment, start-up time, runtime application performance and shutdown time. Any delays when constructing an isolated containerized view of configuration would have significant impact.

In some implementations, such as the Windows registry database implementation, locking and cache access can be performed using a hashing mechanism. Each key entry has a hash table entry associated with it. To scale opening a single registry key entry that uses an additional number of key opens (one at each configuration layer), one hash table entry is associated with the same entry in multiple configuration layers. This enables high scale access across many configuration layers. Other operating systems may implement caching techniques differently. For example in file-based configurations, shortcuts to configuration blocks in files may be used. In graph-based configurations caching requirements may determine a limited set of graph paths to optimize traversal. In other graph-based configurations, path priorities may be set based on caching requirements.

Note there are certain aspects of configuration that may be more valuable to have fast access (and thus pre-fetched into a cache associated with the guest). This includes aspects such as data entry size (e.g. number of data entries for a specific key).

In the event of an implementation in which the configuration store is not in a uniform location (e.g. not on the same physical computer), the configuration engine 208 can maintain a locally shared copy and synchronize updates with a central service. In other implementations, there is no locally shared copy and the configuration engine 208 will implement a caching scheme to store relevant pieces of the base configuration.

Mutable changes to a base configuration layer are uncommon and the probability of managing a transaction conflict is minimal. In some embodiments, in the event a conflict occurs, the service owner is notified to mitigate the conflict; and a configuration update of the base configuration may be used. To minimize conflict in distributed environments with significant network delay, high precision clock synchronization and timestamping of transactions may be used.

The following now illustrates details with respect to security. In some scenarios the guest operating system contains a potentially untrusted differencing hive being loaded with a trusted host hive. There are certain operations that an untrusted user can perform that can potentially result in large parts of the host configuration being promoted from the trusted machine hive in the host into the differencing hive in the guest. Some of this information may be subject to an Access Control List (ACL) setting that is different than the machine configuration. This may violate confidentiality and allowing information disclosure.

To manage this scenario, in the illustrated example, trust classes may be used. Trust classes: associate configuration information with a specific trust level (host-only, guest-only, configuration layer-specific—including spanning host and guest configuration layers, etc.); communicate trust classes to the configuration engine 208 and the filter manager; ensure trust levels appropriately map across configuration layers when within policy; and ensure trust levels do not map across configuration layers when prohibited.

In some embodiments, this means that differencing hive keys or the equivalent configuration data will by definition be unable to receive a full promotion if they are loaded on top of a host (machine) hive. Any operation that requires a full promotion between trust classes will be blocked with an error.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

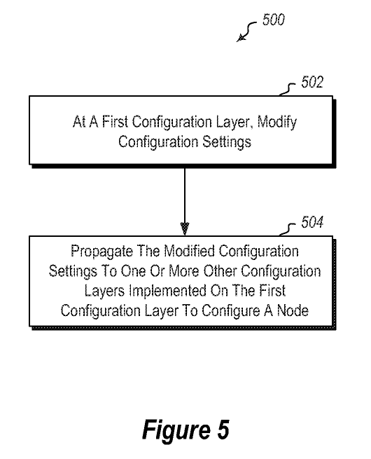

Referring now to FIG. 5, a method 500 is illustrated. The method 500 may be practiced in a computing environment implementing configuration layers for containerized configurations. For example containerized configuration may be a configuration for a containerized operating system kernel or runtime. The method 500 includes acts for configuring a node (such as a operating system kernel or runtime).

The method 500 includes, at a first configuration layer, modifying configuration settings (act 502). For example, with reference to FIG. 2, the host configuration layer 212-H may be modified. For example, this may include modifying one or more of the data sets 204 included in the configuration stores 202. In an alternative embodiment, configuration layer 212-1 or configuration layer 212-2 may be modified by modifying configuration settings in a given configuration layer.

The method 500 further includes propagating the modified configuration settings to one or more other configuration layers implemented on the first configuration layer to configure a node (act 504). For example, the modification of settings in the host configuration layer 212-H or modifications to the configuration layer 212-1 may result in changes being propagated to the configuration layer 212-1-1 and ultimately to the operating system of the virtual machine 214-3. Thus, in this example, the node is an operating system kernel used to host the virtual machine 214-3.

Note that the propagation of changes may be performed while the operating system kernel for the virtual machine 214-3 is running Thus, it is not necessary to shut down a guest operating system kernel to propagate configuration changes to the guest operating system kernel. Also not that the method may be performed in a fashion that is independent of the state of any container. For example, a container (or guest OS, or node) may be running, paused, suspended, stopped, or in any other state.

Additionally or alternatively, propagation of configuration changes to containerized entities may be performed directly or indirectly. For example, in a direct example, if configuration settings are modified at the configuration layer 212-1 and those changes are propagated to the configuration layer 212-1-1 then changes have been propagated directly without any intervening configuration layers. In an indirect example, if the host configuration layer 212-H has configuration settings modified and those settings are propagated through the guest configuration layer 212-1 and the guest configuration layer 212-1-1, then configuration settings are propagated in an indirect fashion.

The method 500 may be practiced where the first configuration layer is modified as a result of an operating system kernel running on one or more of the other configuration layers initiating modification of the first configuration layer. For example, the virtual machine 214-3 may be running on the guest configuration layer 212-1-1 and hosting applications for compatibility a reasons. The virtual machine 214-3 may determine that it needs additional memory resources to continue hosting the applications. The virtual machine 214-3 can indicate to the host configuration layer 212-H that configuration settings should be updated to provide the needed additional memory resources. In some embodiments, the virtual machine 214-3 may be given sufficient permissions to cause the modifications to configuration settings to occur at the host configuration layer 212-H, without any oversight from the host. In other embodiments the virtual machine 214-3 may need to request and authority indicating that the host configuration layer 212-H needs to update its configuration settings. The authority has the ability to grant or deny the request from the guest configuration layer virtual machine 214-3.

In some embodiments, propagating the modified configuration settings to one or more other configuration layers implemented on the first configuration layer includes a first operating system kernel running on one or more of the other configuration layers causing a configuration change to a second operating system kernel running on one or more of the other configuration layers. For example, an operating system kernel running on the guest configuration layer 212-1-2 may push a configuration setting to the host configuration layer 212-H which is then pushed back to the guest configuration layer 212-1-1 to modify an operating system running on the guest configuration layer 212-1-1.

The method 500 may be practiced where the first configuration layer is modified as a result of a host system initiating modification of the first configuration layer. For example, in the example illustrated in FIG. 2 the host configuration layer 212-H may determine that additional or alternate resources are needed and sua sponte modify configuration settings which are propagated as appropriate to upper level configuration layers such as configuration layers 212-1, 212-2, 212-1-1, and 212-1-2. For example, if network or other communication ports need to be changed for upper levels to continue to operate, an operating system kernel running at the host configuration layer 112-H may initiate configuration modifications.

The method 500 may further include notifying a subscriber of one of the one or more other configuration layers of relevant configuration changes caused by modifying configuration settings in the first configuration layer. For example, a subscriber such as an application, operating system kernel, administrator, or other entity may request that it be notified when a particular configuration layer is modified. Embodiments can include functionality for identifying such subscribers and sending such notifications when configuration layers of interest to the subscribers are modified.

The method 500 may be practiced where the first configuration layer is a host configuration layer. For example, the first configuration layer may be a host configuration layer such as the host configuration layer 212-H.

The method 500 may be practiced where the first configuration layer is an intermediate configuration layer between a host configuration layer and the one or more other configuration layers. For example, as illustrated in FIG. 2, the first configuration layer may be the guest configuration layer 212-1.

The method 500 may be practiced where the first configuration layer provides configuration settings to the one or more other configuration layers using an encryption scheme such that the first configuration layer provides configuration settings and hides configuration settings dependent on higher configuration layers' ability to decrypt the settings. In particular, a lower level configuration layer either provides or hides configuration settings to a higher level configuration layer. Thus for example the host configuration layer 212-H is a lower level configuration layer with higher level configuration layers 214-1 and 212-2 running on it. Thus, a configuration layer is higher than another configuration layer if it runs on the other configuration layer. The host configuration layer 212-H can employ an encryption scheme whereby settings are provided to higher level configuration layers but the higher level configuration layers can only access the configuration settings if they possess an appropriate key to decrypt the configuration settings. Otherwise, encryption settings that cannot be decrypted by a higher configuration layer will not be available to that higher configuration layer. Thus, configuration settings are hidden to higher level configuration layers that do not have an appropriate key. In some embodiments, various different keys may be provided to a configuration layer based on the configuration settings desired to be available for a given configuration layer. In an alternative embodiment a particular key may be configured to decrypt any configuration settings intended to be provided to a higher configuration layer.

The method 500 may be practiced where the configuration settings are stored in a configuration database. Thus, for example, in embodiments such as the Windows operating system available from Microsoft Corporation, of Redmond, Wash., configuration settings may be stored in a registry database.

Alternatively or additionally, the method 500 may be practiced where the configuration settings are stored in configuration files. Thus for example, configuration settings may be stored in configuration files such as those available in iOS available from Apple Corporation, of Cupertino, Calif. or in one or more of the various Unix operating systems.

Note that embodiments may be implemented where configuration settings may be stored in a number of different locations of different types. Thus, embodiments may mix storage of configuration settings between database storage and configuration file storage.

Note further, that in some embodiments configuration settings may be stored in a distributed fashion. For example, the Chrome operating system available from Google Corporation, of Mountain View Calif. implements a distributed operating system scheme. Embodiments described herein may be implemented in such operating systems by storing configuration settings in a distributed way with the settings stored on a number of different physical storage devices distributed in various locales.

The method 500 may further include, for an upper configuration layer maintaining an indication of relevant lower configuration layers, wherein the indication of relevant lower configuration layers identifies immutable configuration layers having settings relevant to the upper configuration layer while excluding immutable configuration layers not having settings relevant to the upper configuration layer. For example, a given configuration layer may be dependent on a number of different configuration layers. However, if an immutable configuration layer has no settings (e.g., keys in the Windows example) applicable to the given configuration layer, this can be noted so that the system knows that it is unnecessary to check that configuration layer for updated settings. However, mutable configuration layers may still need to be checked as they may eventually have settings applicable to the given configuration layer. Embodiments may accomplish this in a number of different ways. For example, embodiments may enumerate the layers that do need to be checked for updated setting, the layers that do not need to be checked for updated settings, or some combination.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. This invention is useful in distributed environments where memory and storage space are constrained such as consumer electronics, embedded systems or the Internet of Things (IoT).

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
one or more processors; and
one or more computer-readable media having stored thereon instructions that are executable by the one or more processors that direct the computer system to configure a node, including instructions that are executable to configure the computer system to perform at least the following:
at a first configuration layer, modify configuration settings; and
propagate the modified configuration settings to one or more other configuration layers implemented at the first configuration layer to configure a node.

2. The system of claim 1, wherein the first configuration layer is modified as a result of an operating system kernel running at one or more of the other configuration layers initiating modification of the first configuration layer.

3. The system of claim 2, wherein propagating the modified configuration settings to one or more other configuration layers implemented at the first configuration layer comprises a first operating system kernel running at one or more of the other configuration layers causing a configuration change to a second operating system kernel running at one or more of the other configuration layers.

4. The system of claim 1, wherein one or more computer-readable media further have stored thereon instructions that are executable by the one or more processors to configure the computer system to notify a subscriber of one of the one or more other configuration layers of relevant configuration changes caused by modifying configuration settings in the first configuration layer.

5. The system of claim 1, wherein the first configuration layer is a host configuration layer.

6. The system of claim 1, wherein the first configuration layer is an intermediate configuration layer between a host configuration layer and the one or more other configuration layers.

7. The system of claim 1, wherein the first configuration layer provides configuration settings to the one or more other configuration layers using an encryption scheme such that the first configuration layer provides configuration settings and hides configuration settings dependent on higher configuration layers' ability to decrypt the settings.

8. The system of claim 1, wherein the configuration settings are stored in operating system level configuration files.

9. The system of claim 1, wherein the first configuration layer is based on a first operating system and one or more of the other configuration layers is based on a second operating system.

10. The system of claim 1, wherein one or more configuration settings for the first configuration layer are stored in a first type of configuration storage and one or more configuration settings for one or more of the other configuration layers is stored in a second type of configuration storage.

11. In a computing environment implementing configuration layers for containerized configurations, a method of configuring a node, the method comprising:
at a first configuration layer, modifying configuration settings; and
propagating the modified configuration settings to one or more other configuration layers implemented on the first configuration layer to configure a node.

12. The method of claim 11, wherein the first configuration layer is modified as a result of an operating system kernel running at one or more of the other configuration layers initiating modification of the first configuration layer.

13. The method of claim 12, wherein propagating the modified configuration settings to one or more other configuration layers implemented at the first configuration layer comprises a first operating system kernel running at one or more of the other configuration layers causing a configuration change to a second operating system kernel running at one or more of the other configuration layers.

14. The method of claim 11, wherein the first configuration layer is modified as a result of a host system initiating modification of the first configuration layer.

15. The method of claim 11, further comprising notifying a subscriber of one of the one or more other configuration layers of relevant configuration changes caused by modifying configuration settings in the first configuration layer.

16. The method of claim 11, wherein the first configuration layer is a host configuration layer.

17. The method of claim 11, wherein the first configuration layer is an intermediate configuration layer between a host configuration layer and the one or more other configuration layers.

18. The method of claim 11, wherein the first configuration layer provides configuration settings to the one or more other configuration layers using an encryption scheme such that the first configuration layer provides configuration settings and hides configuration settings dependent at higher configuration layers' ability to decrypt the settings.

19. The method of claim 11, further comprising inserting or deleting a layer, and as a result propagating configuration settings to one or more of the other configuration layers.

20. The method of claim 11, further comprising inspecting the first configuration layer and the one or more other configuration layers to identify duplicate configuration settings and performing a deduplication processes on the duplicate configuration settings.

21. The method of claim 11, further comprising, for an upper configuration layer maintaining an indication of relevant lower configuration layers, wherein the indication of relevant lower configuration layers identifies immutable configuration layers having settings relevant to the upper configuration layer while excluding immutable configuration layers not having settings relevant to the upper configuration layer.

22. A system for configuring containerized entities, the system comprising:
a first configuration layer, wherein the first configuration layer is configured to be modified via configuration settings at the first configuration layer;
one or more other configuration layers implemented at the first configuration layer to configure a node; and
a configuration engine configured to propagate settings modified at the first configuration layer to the one or more other configuration layers.
